(19) United States
(12) Patent Application Publication
(10) Pub. No.: US 2025/0215923 A1
(43) Pub. Date: Jul. 3, 2025

(54) PRE-LOADED DUAL-BEARING ASSEMBLY WITH ANNULAR CANTILEVER BEAM SPRING

(71) Applicant: Raytheon Company, Tewksbury, MA (US)

(72) Inventors: Gary J. Sutton, Oro Valley, AZ (US); Christopher P. Owan, Tucson, AZ (US); Nicholas R. Leslie, Tucson, AZ (US)

(21) Appl. No.: 18/441,726

(22) Filed: Feb. 14, 2024

Related U.S. Application Data
(60) Provisional application No. 63/615,150, filed on Dec. 27, 2023.

(51) Int. Cl. F16C 25/08; F16C 19/08; F16F 1/18

(52) U.S. Cl. CPC F16C 25/083; F16C 19/08; F16F 1/187

(57) ABSTRACT

A dual-bearing assembly includes an annular cantilever beam spring positioned in-line and either internal or external to a pair of bearings. The spring includes first and second sets of N stand-offs evenly positioned around opposing top and bottom surfaces of a flat annular beam at 360/N degree intervals and angularly offset with respect to each other by 360/2N degrees such that each said stand-off is evenly spaced between adjacent pairs of stand-offs on the opposing surface. A pre-load mechanism is configured to apply opposing axial loads to the stand-offs to deflect the flat annular beam axially at each stand-off in opposing directions to induce a curvature to the annular beam and store energy in the beam to form load paths through the spring and rolling elements to pre-load the dual-bearing assembly. The dual-bearing assembly may be configured as DB, DF, universal or tandem. The spring stiffness is determined by the elastic material properties of the flat annular beam, not the initial geometry as is common with the COTS springs.

### CROSS-REFERENCE TO RELATED APPLICATIONS

This application claims benefit of priority under 35 U.S.C. 119 (e) to U.S. Provisional Application No. 63/615,150 entitled “ANNULAR CANTILEVER BEAM SPRING AND PRE-LOADED ASSEMBLY” and filed on Dec. 27, 2023, the entire contents of which are incorporated by reference.

### BACKGROUND

### Field

This disclosure relates to a pre-loaded dual-bearing assembly to facilitate precise control over the operating geometry of the bearings' mating parts.

### Description of the Related Art

A bearing is a machine element that constrains relative motion to only the desired motion and reduces friction between moving. The design of the bearing may, for example, provide for free liner movement of the moving part or for free rotation about a fixed axis. Rotary bearings hold rotating components such as shafts or axles within mechanical systems and transfer axial and radial loads from the source of the load to the structure supporting it. In a ball bearing or roller bearing, to reduce sliding friction, rolling elements such as roller or balls with a circular cross-section are located between inner and outer races of the bearing assembly.

As depicted in FIGS. 1A and 1B, a dual-bearing assembly 100 including first and second ball or roller bearings 102 and 104, respectively, can be used to support larger loads and to avoid lost or undesired motion. This particular assembly is a special Duplex bearing in which each bearing includes rolling elements 106 positioned in a retainer 107 and located between inner and outer races 108 and 110 to allow for rotation about an axis 112. Dual-bearings may be configured front-to-front (DF), back-to-back (DB), either (Universal) or in the same direction (Tandem). To reduce friction and lost motion, any axial or radial misalignment 114 between the two bearings must be minimized. Due to imperfections in the backward or forward facing axial surfaces of commercial off-the-shelf (COTS) bearings steps must be taken to ensure proper alignment.

Pre-loading facilitates precise control over the operating geometry of the bearings' mating parts. More specifically, pre-loading removes the free axial and radial play for precise shaft positioning. With the removal of free play, the geometries of the bearings dictate the radial and axial run-outs. Pre-loading establishes a precise amount of axial and radial stiffness. The spring rates in the axial and radial directions are constant as long as the preload is maintained. Properly designed preloading keeps the rolling elements under load in high speed or rapid acceleration/deceleration operation.

Referring now to FIGS. 2A-2D, one approach to ensure proper alignment of COTS bearings is to position a COTS spring 200 in-line and internal (between) or external (outside) first and second COTS bearings 202 and 204, respectively, an apply a pre-load to the assembly, which has the effects of both compressing spring 200 to compensate for imperfections in the axial facing surfaces to properly align the bearings and to pre-load the rolling elements 206 to contact both the inner and outer races 208 and 210, respectively in a static condition (i.e., remove the “slack” from the bearing assembly 212) such that the bearing assembly either does not respond to external forces or responds to those forces in a known manner. A coil spring 230 is formed by winding a wire around a cylinder. Its stiffness properties are largely determined by its geometry including the number and radius of the turns. To provide high stiffness, a coil spring typically requires many turns and thus will be thick and exhibit a low stiffness/volume. A wave spring 240 is a flat-wire compression spring, which may have a single layer as shown or in a stack. Wave springs typically exhibit low stiffness in order to accommodate a wide deflection range. A pre-load mechanism 213 such as a threaded nut or clamp 214 and housing 216 applies an axial load 218 to the bearings and the spring to compress and pre-load the assembly. COTS springs can achieve the specified alignment precision but suffer from increased friction, hence latency, due to increased axial and radial motion at the contact points of the spring and spacing between the bearings to provide adequate stiffness.

A Duplex or Super-Duplex bearing is a custom built DB, DF, universal or tandem bearing that provides both the specified alignment precision and low friction/latency without spacing the bearings. The axial facing surfaces of the Duplex or Super-Duplex bearing are precisely and iterative ground, assembled in direct contact with each other and tested under pre-load until the specified alignment precision is achieved. This is a time consuming and expensive process. These Duplex or Super-Duplex bearings exhibit a much higher overall spring constant due to the direct contact and provide the greatest control over pre-load and the best friction/hysteresis performance. However, their cost typically limits their application to systems that demand extremely low friction and hysteresis.

### SUMMARY

The following is a summary that provides a basic understanding of some aspects of the disclosure. This summary is not intended to identify key or critical elements of the disclosure or to delineate the scope of the disclosure. Its sole purpose is to present some concepts of the disclosure in a simplified form as a prelude to the more detailed description and the defining claims that are presented later.

The present disclosure provides a pre-loaded dual-bearing assembly using a spring capable of exhibiting low friction and hysteresis and stiffness and specifically stiffness/volume far exceeding currently available COTS springs to provide performance comparable to a Duplex bearing.

A dual-bearing assembly includes first and second bearings positioned to rotate about an axis, each bearing including inner and outer races and a plurality of rolling elements between the inner and outer races to allow the races to rotate about the axis relative to each other. An annular cantilever beam spring is positioned about the axis in-line with and internal or external to the first and second bearings. A pre-load mechanism is configured to apply opposing axial loads to the first and second bearings and spring to compress the spring and apply a pre-load within a specified operating range of the assembly.

The annular cantilever beam spring includes a flat annular beam sized to match either the inner or outer race of each bearing, said flat annular beam having top and bottom surfaces about the axis. A first set of N stand-offs where N is an integer of 3 is evenly spaced at 360/N degree intervals about the top surface of the flat annular beam to engage an axial facing surface of the inner or outer race of the first bearing. A second set of N stand-offs is evenly spaced at 360/N degree intervals about the bottom surface of that flat annular beam to engage an axial facing surface of the inner or outer race of the second bearing or an axial facing surface of the pre-load mechanism. The first and second sets of stand-offs are angularly offset from each other by 360/2N degrees such that each stand-off is evenly spaced between adjacent pairs of stand-offs on the opposing surface. The first and second set of stand-offs responsive to the opposing axial loads to deflect the flat annular beam axially at each stand-off in opposing directions to induce a curvature to the annular beam and store energy in the beam to form load paths through the spring and rolling elements to pre-load the dual-bearing assembly.

The first and second bearings may be arranged as a DB configuration with an external spring mount, a DF configuration with an external spring mount, a DB configuration with an internal spring mount or a DF configuration with an internal spring mount, a universal configuration or a tandem configuration. A shaft is mounted along the axis through the first and second bearings and supported on the inner races.

The spring stiffness is determined by the elastic material properties of the flat annular beam, not the initial geometry as is common with the COTS springs. This serves to provide the much higher stiffness/spring volume. As the spring is pre-loaded to induce curvature in flat annular beam, the radius contracts. This contraction is real but negligible producing negligible friction and thus hysteresis. Furthermore, the opposing axial loads are only applied to the stand-offs, the flat annular beam itself is not directly loaded. This reduces the contact area, hence friction, and maintains a linear spring response.

In general, each stand-off may include one or more closely-spaced protrusions. In certain embodiments, each stand-off includes a single protrusion. In a preferred embodiment, N=3, and the stand-offs are evenly spaced at 120 degrees around the flat annular beam and the first and second sets are rotated by 60 degrees with respect to each other.

In different embodiments, the spring may be formed of conventional spring materials such as aluminum or titanium or the same material as an assembly in which the spring is used such as 440C stainless steel, 52100 chrome steel or ceramics. Proper selection of the spring materials may provide a dual-bearing assembly that is athermal (thermally stable).

These and other features and advantages of the disclosure will be apparent to those skilled in the art from the following detailed description of preferred embodiments, taken together with the accompanying drawings, in which:

### BRIEF DESCRIPTION OF THE DRAWINGS

FIGS. 1A-1B, as described above, are perspective and section views of a dual-bearing assembly;

FIGS. 2A-2-D, as described above, are views of a pre-loaded dual-bearing assembly, compression and wave springs and a bearing under pre-load;

FIGS. 3A-3B are views of an annular cantilever beam spring;

FIGS. 4A-4B are views of an annular cantilever beam spring in which opposing axial loads have been applied to deflect the flat annular beam axially in opposing directions to induce a curvature into the annular beam and store energy in the beam;

FIGS. 5A-5B are views of alternative embodiments of the annular cantilever beam spring in which each stand-off includes two or three protrusions;

FIGS. 6A-6B are exploded and assembled views of a DB dual-bearing configuration with an internal spring mount;

FIGS. 7A-7B illustrate spring deflection vs. preload and stiffness/volume for various COTS springs, the annular cantilever beam spring and the Duplex bearing configuration;

FIG. 8 is a plot of spring rate/volume for the annular cantilever beam spring and various COTS springs;

FIG. 9 is a DF dual-bearing configuration with an internal spring mount.

FIG. 10 is a DB dual-bearing configuration with an external spring mount; and

FIG. 11 is a DF dual-bearing configuration with an external spring mount.

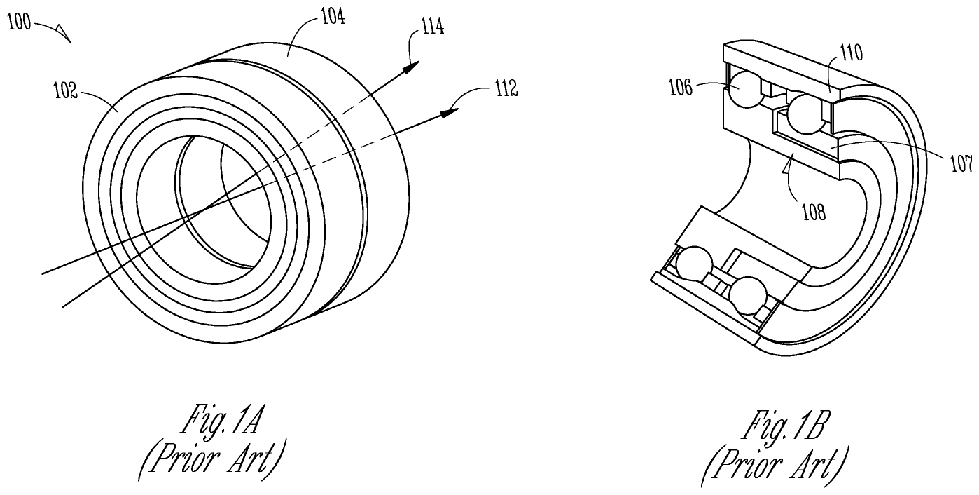

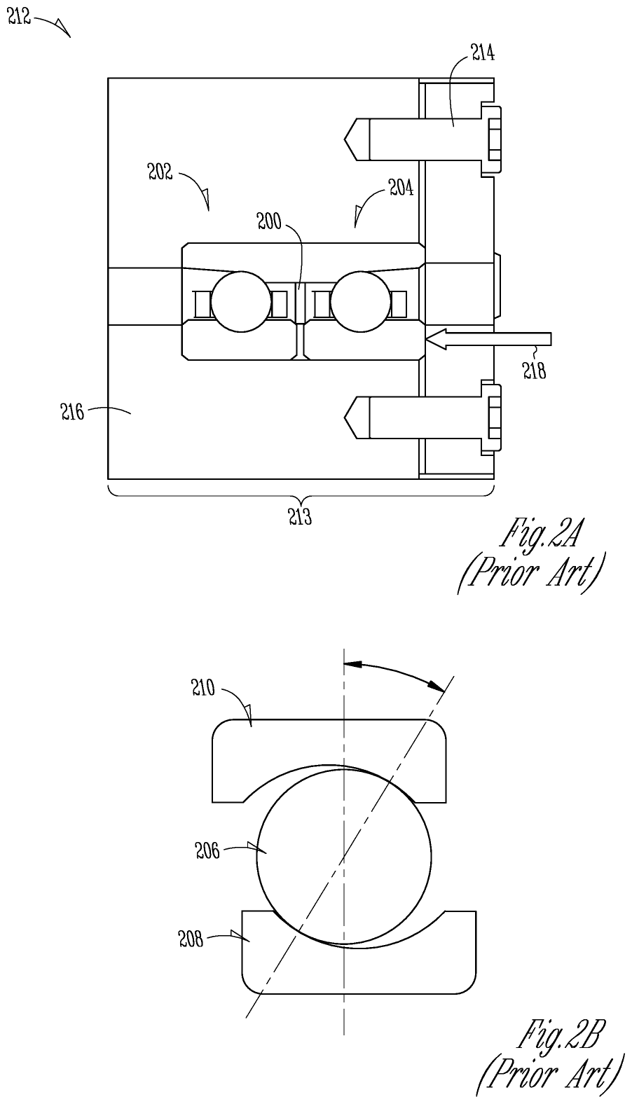

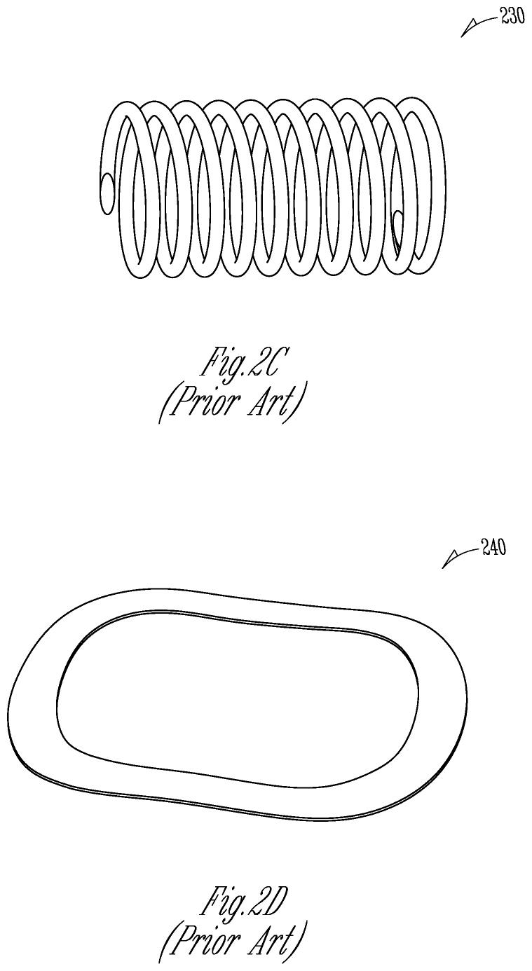

### DETAILED DESCRIPTION

The present disclosure provides a pre-loaded dual-bearing assembly using a spring capable of exhibiting low friction and hysteresis and stiffness and specifically stiffness/volume far exceeding currently available COTS springs to provide performance comparable to a Duplex or Super-Duplex bearing. Low friction, hence low hysteresis is due to minimal movement at contact points in both the axial and radial directions when force is exerted on the spring. The spring stiffness is determined by the elastic material properties of the spring, not the initial geometry as is common with the COTS springs. This serves to provide the much higher stiffness/spring volume. Unlike COTS springs, compression induces a curvature into the spring to store energy.

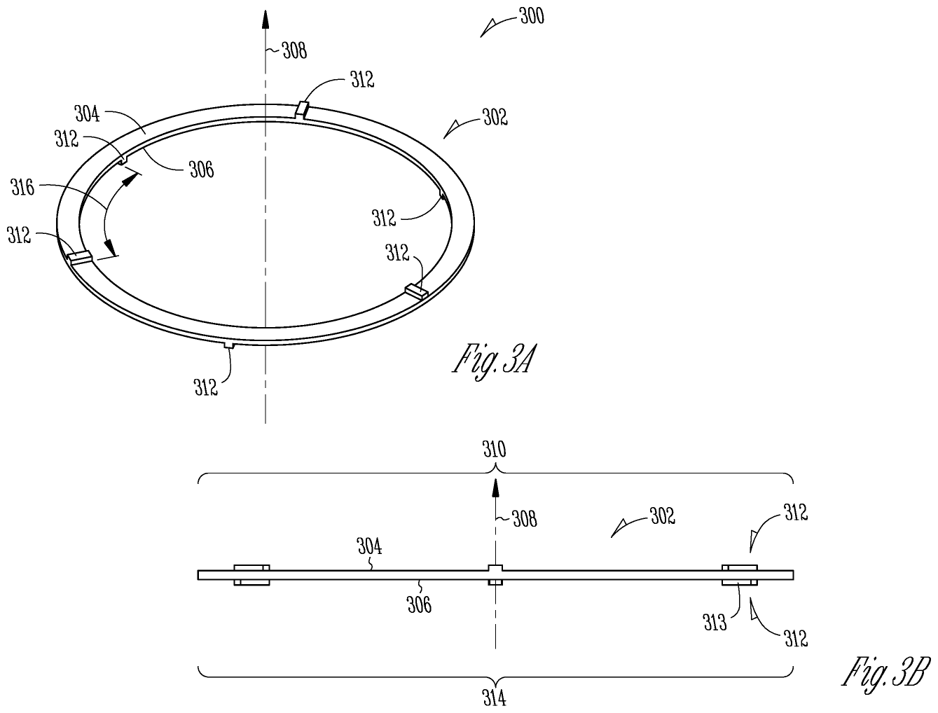

Referring now to FIGS. 3A-3B, an annular cantilever beam spring 300 includes a flat annular beam 302 having opposing top and bottom surfaces 304 and 306, respectively, about an axis 308. A first set 310 of N stand-offs 312 where N is an integer of 3 or more extends from and is evenly spaced at 360/N degree intervals about the top surface 304. A second set 314 of N stand-offs 312 extends from and is evenly spaced at 360/N degree intervals about the bottom surface 306. Each stand-off 312 is made up of one or more protrusions 313 that are closely spaced at the corresponding angular interval. The first and second sets 310 and 314 of stand-offs 312 are angularly offset from each other by an offset 316 of 360/2N degrees such that each said stand-off 312 is evenly spaced between adjacent pairs of stand-offs 312 on the opposing surface. Although N may be any integer greater than 3 a top end of the range is practically 8, which corresponds to an angular spacing of every 45 degrees. N=3 is a preferable number as 3 stand-offs establish a plane. More than 3 stand-offs contacting simultaneously, which will introduce a secondary contact event. At N=3, the stand-offs on each side are spaced at 120 degrees and the angular offset is 60 degrees.

The spring stiffness is determined by the elastic properties of the material itself as well as the ID, OD and thickness of the flat annular beam 302. The spring material may be selected to match the mating parts in any assembly such as 440C stainless steel, 52100 chrome steel or a ceramic. Alternately, the spring material may be a common spring material such as aluminum or titanium. The maximum deflection is determined by the height of the stand-offs 312.

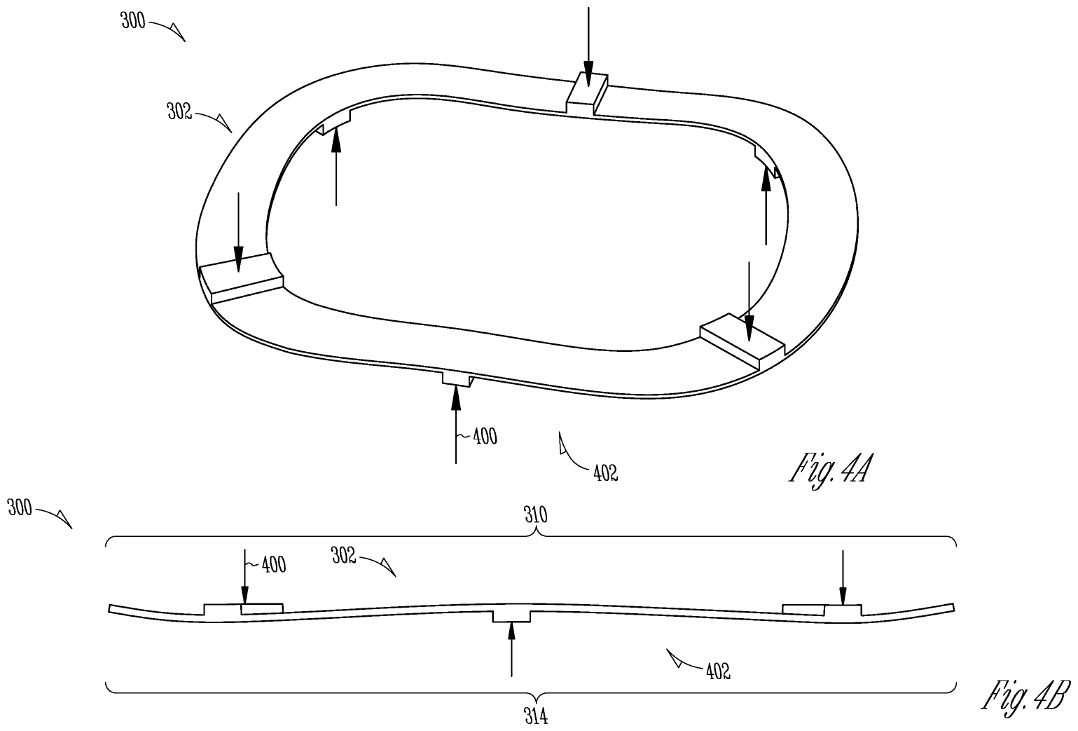

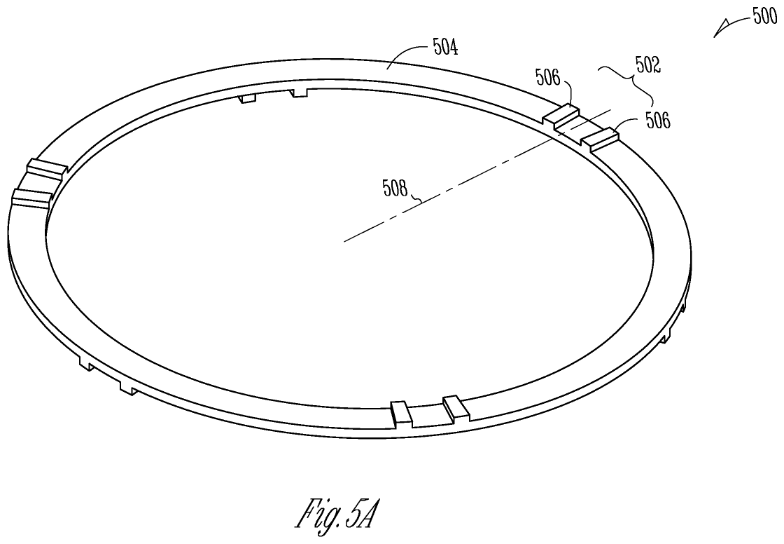

Referring now to FIGS. 4A-4B, the first and second sets 310 and 314, respectively of stand-offs 312 are responsive to opposing axial loads 400 to deflect the flat annular beam 302 axially at each stand-off 312 in opposing directions to induce a curvature 402 to the flat annular beam 302 and store energy in the beam.

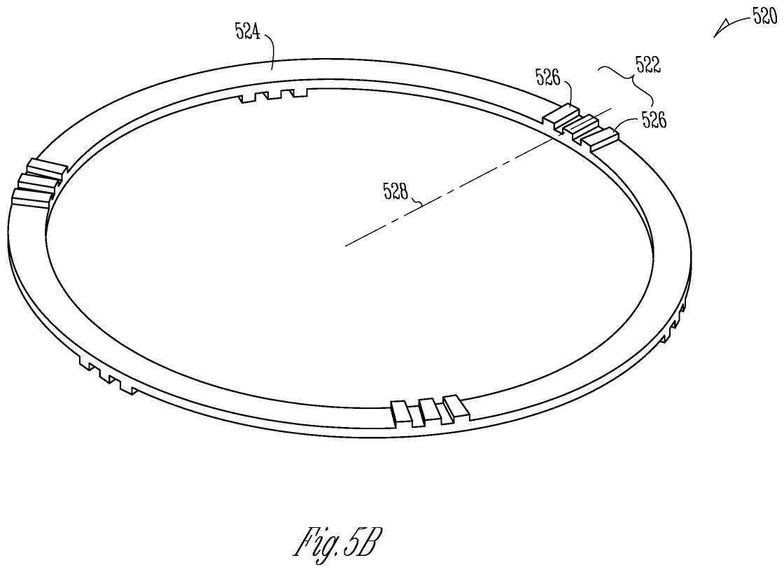

Referring now to FIGS. 5A-5B, in these embodiments each stand-off includes multiple protrusions closely spaced at the corresponding angular interval. A annular cantilever beam spring 500 includes N=3 stand-offs 502 evenly spaced at 120 degree intervals on opposing sides of a flat annular beam 504. Each stand-off 502 includes two protrusions 506 equally and closely spaced from an angular interval 508. A annular cantilever beam spring 520 includes N=3 stand-offs 522 evenly spaced at 120 degree intervals on opposing sides of a flat annular beam 524. Each stand-off 522 includes three protrusions 526 equally and closely spaced about an angular interval 528.

The annular beam spring can be used to pre-load an assembly to remove any “slack” in the assembly, ensure proper alignment and to place the assembly in an operating range in which the assembly either does not respond to external forces or responds to those forces in a known manner. Pre-loading with the annular beam spring minimizes any friction and resulting hysteresis (latency) or lost motion from the assembly. Friction is negligible due to minimal movement at contact points in both the axial and radial directions when force is exerted. Furthermore, because the annular beam spring exhibits high spring rate (stiffness)/volume, the spring itself occupies minimal space.

A pre-loaded assembly includes first and second mating parts positioned along an axis and an annular cantilever beam spring positioned about the axis in-line with and internal or external to the first and second mating parts. A pre-load mechanism is configured to apply opposing axial loads to the first and second mating parts and the stand-offs on the opposing surfaces of the flat annular beam to deflect the flat annular beam axially at each stand-off in opposing directions to induce a curvature to the annular beam and store energy in the beam to preload the assembly.

The spring stiffness is determined by the elastic material properties of the flat annular beam, not the initial geometry as is common with the COTS springs. This serves to provide the much higher stiffness/spring volume. As the spring is pre-loaded to induce curvature in flat annular beam, the radius contracts. This contraction is real but negligible producing negligible friction and thus hysteresis. Furthermore, the opposing axial loads are only applied to the stand-offs, the flat annular beam itself is not directly loaded. This reduces the contact area, hence friction, and maintains a linear spring response. The spring is preferably designed for a given application to provide sufficient deflection clearance under the applied pre-load such that the beam does not “bottom out” in order to preserve a linear spring response.

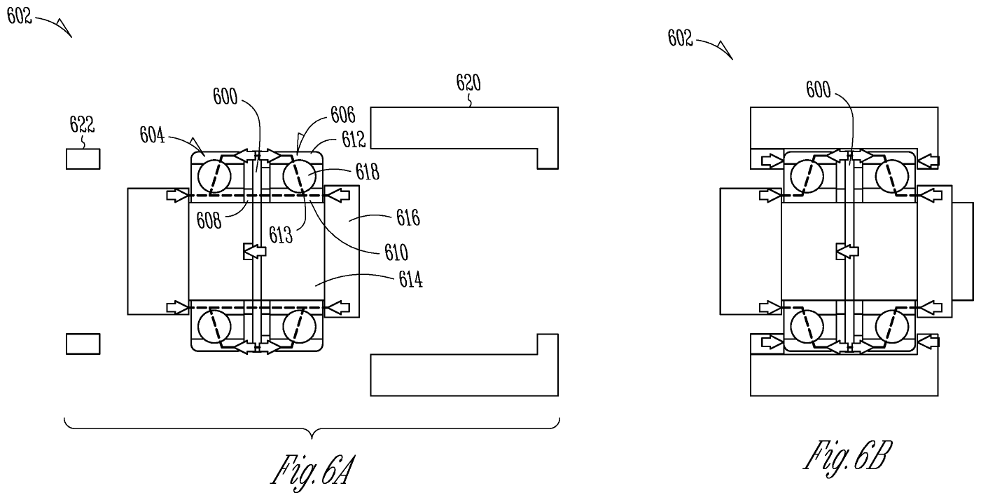

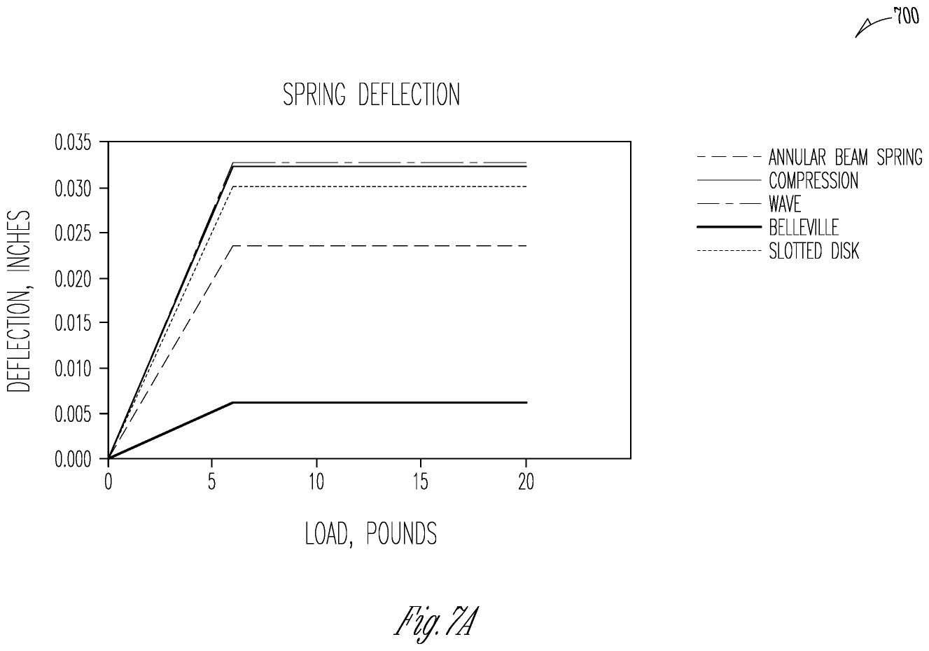

Referring now to FIGS. 6A-6B, in an embodiment an annular beam spring 600 is employed to pre-load a dual-bearing assembly 602, in particular a DB mounting-internal spring mount configuration. In a DB mounting the contact angles diverge at the axis of rotation. DB is used when high bending stiffness of the shaft or rotating members is required and the load is applied outside of the mounted bearings such as in a cantilever type load. The annular beam spring may also be used with a DB mounting with external spring mount or a DF mounting with an internal or external spring mount.

Dual-bearing assembly 602 includes first and second bearings 604 and 606, respectively, having axial facing front and back surfaces. A spacer 608 (e.g., a shim or sleeve) and the annular beam spring 600 are positioned between the bearings' axial facing back surfaces opposite the inner and outer races 610 and 612, respectively. This assembly is installed on a shaft 614 that creates an axis of rotation and clamped via a pre-load mechanism 616. The bearings make solid contact at the inner races 610 during installation. The spring 600 is compressed to induce curvature in the flat annular beam to its working height between the outer races 612 to generate load paths 613 from the inner race 610, through a rolling element 618 (e.g. a ball), the outer race 612, the spring 600, the opposing outer race 612, rolling element 618 and the inner race 610. A housing 620 is placed over the bearings, and the spring and bearings' outer races 612 are clamped in place between housing 620 and stop 622. Spacer 608 provides a path for the load to transfer from the inner to the outer race and back through the inner race. The spacer must be thinner than the spring but thick enough so that the desired deflection at pre-load is met. If the spacer is not properly sized, the spring will not engage and the outer races will be free to float.

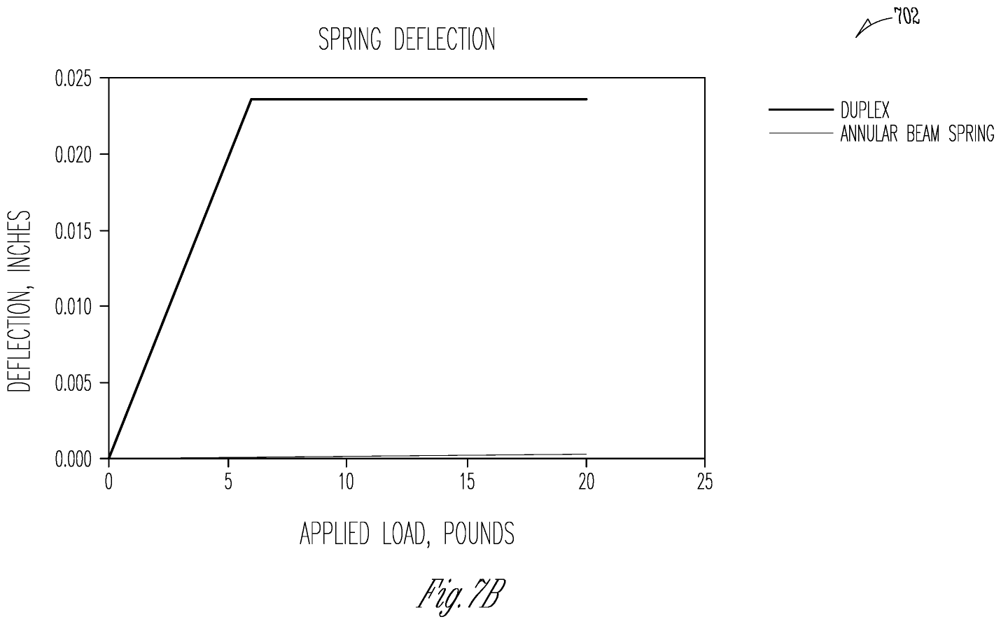

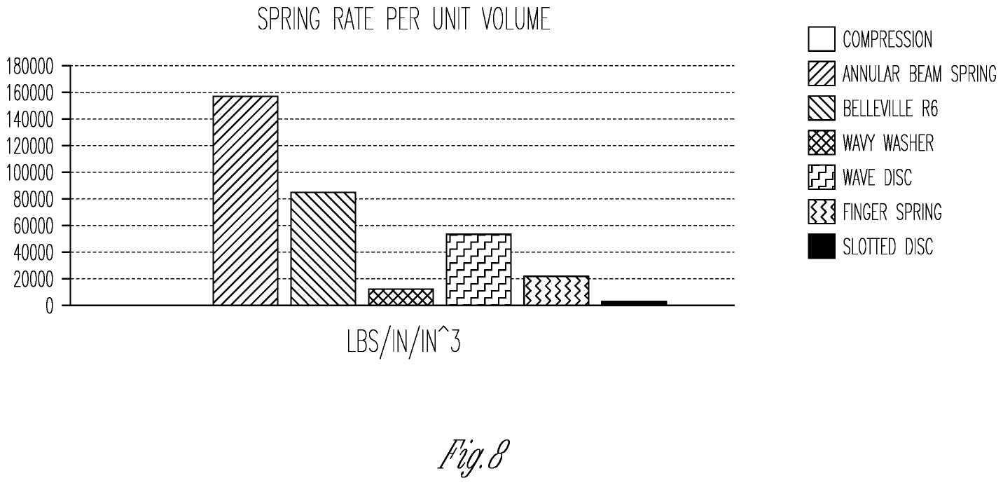

Referring now to FIGS. 7A-7B, plots for spring deflection vs load 700 and 702 and FIG. 8 a plot for spring rate (stiffness) per unit volume 800 are presented for various COTS springs, a Duplex bearing configuration and the annular beam spring. With the exception of the Belleville washer, the springs are sized to match the outer race, and more particularly the landing area, of the outer race on the springs. The conic shape of the Belleville washer is simply not amenable to engage the same race, inner or outer, on a pair of bearings. As shown, COTS coil, wave and slotted disk springs exhibit greater deflection (are less stiff) than the annular beam spring, and most particular exhibit a much lower spring rate per unit volume than the annular beam spring. The Belleville washer is stiffer and has a spring rate per unit volume closer to the annular beam spring but again cannot be used where the spring must have the same diameter on both sides to match equal size bearings, or more generically, equal sized mating parts. The Duplex bearing configuration is much stiffer than any spring.

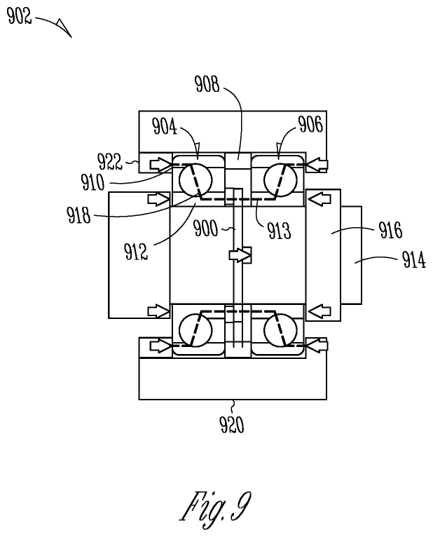

Referring now to FIG. 9, in an embodiment an annular beam spring 900 is employed to pre-load a dual-bearing assembly 902, in particular a DF mounting-internal spring mount configuration. In a DF mounting the contact angles converge at the axis of rotation. DF is used when some give is required for misalignment and low friction is a priority.

Dual-bearing assembly 902 includes first and second bearings 904 and 906, respectively, having axial facing front and back surfaces. A spacer 908 (e.g., a shim or sleeve) and the annular beam spring 900 are positioned between the bearings' axial facing back surfaces opposite the outer and inner races 910 and 912, respectively. This assembly is installed on a shaft 914 that creates an axis of rotation and clamped via a pre-load mechanism 916. The bearings make solid contact at the outer races 910 during installation. The spring 900 is compressed to induce curvature in the flat annular beam to its working height between the inner races 912 to generate load paths 913 from the outer race 910, through a rolling element 918 (e.g. a ball), the inner race 912, the spring 900, the opposing inner race 912, rolling element 918 and the outer race 910. A housing 920 is placed over the bearings, and the spring and bearings' inner races 912 are clamped in place between housing 920 and stop 922. Spacer 908 provides a path for the load to transfer from the outer to the inner race and back through the outer race. The spacer must be thinner than the spring but thick enough so that the desired deflection at pre-load is met. If the spacer is not properly sized, the spring will not engage and the outer races will be free to float.

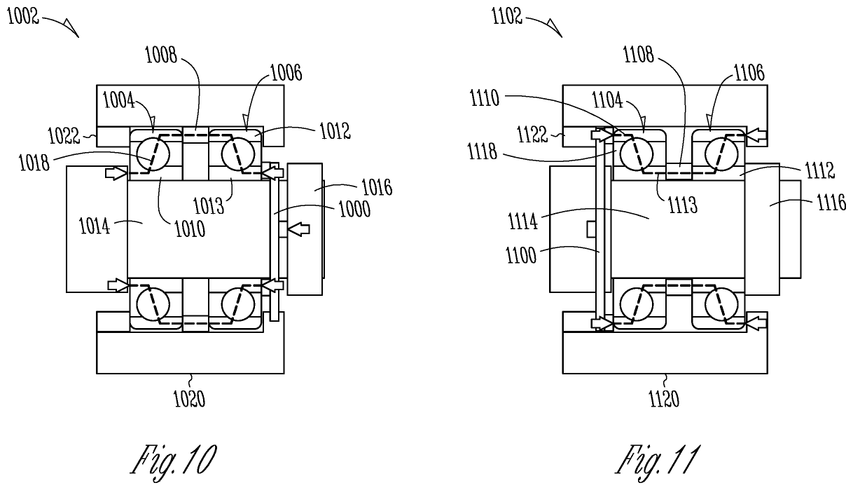

Referring now to FIG. 10, in an embodiment an annular beam spring 1000 is employed to pre-load a dual-bearing assembly 1002, in particular a DB mounting-external spring mount configuration. Dual-bearing assembly 1002 includes first and second bearings 1004 and 1006, respectively, having axial facing front and back surfaces. A spacer 1008 (e.g., a shim or sleeve) is positioned between the bearings' axial facing back surfaces opposite the outer races 1012. The annular beam spring 1000 is positioned external to the bearings between the second bearings' inner race 1010 and a pre-load mechanism 1016. This assembly is installed on a shaft 1014 that creates an axis of rotation and clamped via the pre-load mechanism 1016. The bearings make solid contact at the outer races 1012 during installation. The spring 1000 is compressed to induce curvature in the flat annular beam to its working height between the inner race 1010 and pre-load mechanism 1016 to generate load paths 1013 from the inner race 1010, through a rolling element 1018 (e.g. a ball), the outer race 1012, through spacer 1008, the opposing outer race 1012, rolling element 1018 and the inner race 1010. A housing 1020 is placed over the bearings, and the spring and bearings' outer races 1012 are clamped in place between housing 1020 and stop 1022.

Referring now to FIG. 11, in an embodiment an annular beam spring 1100 is employed to pre-load a dual-bearing assembly 1102, in particular a DF mounting-external spring mount configuration. Dual-bearing assembly 1102 includes first and second bearings 1104 and 1106, respectively, having axial facing front and back surfaces. A spacer 1108 (e.g., a shim or sleeve) is positioned between the bearings' axial facing front surfaces opposite the inner races 1112. The annular beam spring 1100 is positioned external to the bearings between the second bearings' outer race 1010 and a stop 1122. This assembly is installed on a shaft 1114 that creates an axis of rotation and clamped via a pre-load mechanism 1116. The bearings make solid contact at the inner races 1112 during installation. The spring 1100 is compressed to induce curvature in the flat annular beam to its working height between the outer race 1110 and stop 1122 to generate load paths 1113 from the outer race 1110, through a rolling element 1118 (e.g. a ball), the inner race 1112, through spacer 1108, the opposing inner race 1112, rolling element 1118 and the outer race 1110. A housing 1120 is placed over the bearings, and the spring and bearings' inner races 1112 are clamped in place between housing 1120 and stop 1122.

While several illustrative embodiments of the disclosure have been shown and described, numerous variations and alternate embodiments will occur to those skilled in the art. Such variations and alternate embodiments are contemplated, and can be made without departing from the spirit and scope of the disclosure as defined in the appended claims.

We claim:

1. A dual-bearing assembly, comprising:
first and second bearings positioned to rotate about an axis, each bearing including inner and outer races and a plurality of rolling elements between the inner and outer races to allow the races to rotate about the axis relative to each other;
an annular cantilever beam spring positioned about the axis in-line with and internal or external to the first and second bearings; and
a pre-load mechanism configured to apply opposing axial loads to the first and second bearings and spring to compress the spring and apply a pre-load within a specified operating range of the assembly,
wherein the annular cantilever beam spring comprises:
a flat annular beam sized to match either the inner or outer race of each bearing, said flat annular beam having top and bottom surfaces about the axis;
a first set of N stand-offs where N is an integer of 3 or more extending from and evenly spaced at 360/N degree intervals about the top surface of the flat annular beam to engage an axial facing surface of the inner or outer race of the first bearing; and
a second set of N stand-offs extending from and evenly spaced at 360/N degree intervals about the bottom surface of that flat annular beam to engage an axial facing surface of the inner or outer race of the second bearing or an axial facing surface of the pre-load mechanism,
wherein first and second sets of stand-offs are angularly offset from each other by 360/2N degrees such that each said stand-off is evenly spaced between adjacent pairs of stand-offs on the opposing surface,
said first and second set of stand-offs responsive to the opposing axial loads to deflect the flat annular beam axially at each stand-off in opposing directions to induce a curvature to the annular beam and store energy in the beam to form load paths through the spring and rolling elements to pre-load the dual-bearing assembly.

2. The dual-bearing assembly of claim 1, further comprising:
a shaft positioned along the axis and through the first and second bearings supported by the inner races.

3. The dual-bearing assembly of claim 2, wherein the first and second bearings have axial facing front and back surfaces and the assembly is a back-to-back (DB) mounting with an external spring mount in which a spacer is positioned between the first and second bearings' axial facing back surfaces opposite the outer races and the spring is placed opposite the second bearing's axial facing front surface, wherein the opposing axial loads compress the assembly such that the inner races do not contact each other and the loads paths pass through the spacer.

4. The dual-bearing assembly of claim 2, wherein the first and second bearings have axial facing front and back surfaces and the assembly is a front-to-front (DF) mounting with an external spring mount in which a spacer is positioned between the first and second bearings' axial facing front surfaces opposite the inner races and the spring is placed opposite the first bearing's axial facing back surface, wherein the opposing axial loads compress the assembly such that the outer races do not contact each other and the loads paths pass through the spacer.

5. The dual-bearing assembly of claim 2, wherein the first and second bearings have axial facing front and back surfaces and the assembly is a back-to-back (DB) mounting with an internal spring mount in which a spacer and the spring are positioned between the first and second bearings' axial facing back surfaces opposite the inner and outer races, respectively, wherein the opposing axial loads compress the assembly such that the load transfers from the inner to the outer races and through the spring.

6. The dual-bearing assembly of claim 2, wherein the first and second bearings have axial facing front and back surfaces and the assembly is a front-to-front (DF) mounting with an internal spring mount in which a spacer and the spring are positioned between the first and second bearings' axial facing front surfaces opposite the outer and inner races, respectively, wherein the opposing axial loads compress the assembly such that the load transfers from the outer to the inner races and through the spring.

7. The dual-bearing assembly of claim 1, wherein each stand-off comprises one or more protrusions.

8. The dual-bearing assembly of claim 7, wherein each stand-off comprises a single protrusion.

9. The dual-bearing assembly of claim 8, wherein N=3, the stand-offs are evenly spaced at 120 degrees around the flat annular beam and the first and second sets are rotated by 60 degrees with respect to each other.

10. The dual-bearing assembly of claim 1, wherein a radius of the flat annular beam contracts as the curvature is induced in the annular beam.

11. The dual-bearing assembly of claim 1, wherein the axial facing surfaces of the first bearing and the second bearing or pre-load mechanism only contact the stand-offs and not the flat annular beam as curvature is induced.

12. The dual-bearing assembly of claim 1, wherein the flat annular beam and stand-offs are formed of a material selected from aluminum or titanium.

13. The dual-bearing assembly of claim 1, wherein the flat annular beam and stand-offs are formed of the same material as the first and second bearings.

14. The dual-bearing assembly of claim 1, wherein the flat annular beam and stand-offs are formed of a material such that the dual-bearing assembly is athermal.

15. A method of pre-loading a dual-bearing assembly, said assembly including first and second bearings positioned to rotate about an axis, each bearing including inner and outer races and a plurality of rolling elements between the inner and outer races to allow the races to rotate about the axis relative to each other, said method comprising:
providing an annular cantilever beam spring that includes a flat annular beam, first and second sets of N stand-offs where N is an integer of 3 or more extending from and evenly spaced at 360/N degree intervals top and bottom surfaces of the beam, in which the first and second sets of stand-offs are angularly offset from each other by 360/2N degrees such that each said stand-off is evenly spaced between adjacent pairs of stand-offs on the opposing surface,
placing the spring about the axis and in-line with and internal or external to the first and second bearings' inner or outer races; and
applying opposing axial loads to the assembly and to the first and second sets of stand-offs to deflect the flat annular beam axially at each stand-off in opposing directions to induce a curvature to the annular beam and store energy in the beam to form load paths through the spring and rolling elements to pre-load the dual-bearing assembly.

16. The method of claim 15, further comprising:
mounting a shaft positioned along the axis and through the first and second bearings supported by the inner races.

17. The method of claim 15, wherein N=3, the stand-offs are evenly spaced at 120 degrees around the flat annular beam and the first and second sets are rotated by 60 degrees with respect to each other.

18. The method of claim 15, wherein a radius of the flat annular beam contracts as the curvature is induced in the annular beam.

19. The method of claim 15, wherein a axial facing surfaces of the first bearing and the second bearing or a pre-load mechanism only contact the stand-offs and not the flat annular beam as curvature is induced.
